(19) United States
(12) Patent Application Publication
(10) Pub. No.: US 2026/0284975 A1
(43) Pub. Date: Sep. 24, 2026

(54) METHOD FOR PRODUCING THREE-DIMENSIONAL OBJECT

(71) Applicant: SEIKO EPSON CORPORATION, Tokyo (JP)

(72) Inventor: Masaaki OGIHARA, MATSUMOTO-SHI (JP)

(21) Appl. No.: 19/574,789

(22) Filed: Mar. 23, 2026

(30) Foreign Application Priority Data
Mar. 24, 2025 (JP) 2025-048400

(51) Int. Cl. B29C 64/321; B29C 64/106; B29C 64/209; B33Y 10/00

(52) U.S. Cl. CPC B29C 64/321; B29C 64/106; B29C 64/209; B33Y 10/00

(57) ABSTRACT

A method for producing a three-dimensional object in a three-dimensional modeling apparatus including a plasticizing unit including a screw and a motor configured to rotate the screw, the plasticizing unit being configured to plasticize a material to generate a plasticized material, a flow path configured to allow the plasticized material to pass therethrough, a nozzle including a nozzle opening and configured to discharge the plasticized material that passes through the flow path from the nozzle opening toward a stage, and a position changing unit configured to change a relative position between the stage and the nozzle, includes: a deceleration step of reducing a relative speed of the nozzle with respect to the stage, in which in the deceleration step, the screw is reversely rotated.

The present application is based on, and claims priority from JP Application Serial Number 2025-048400, filed March 24, 2025, the disclosure of which is hereby incorporated by reference herein in its entirety.

### BACKGROUND

### 1. Technical Field

The present disclosure relates to a method for producing a three-dimensional object.

### 2. Related Art

There is a method for producing a three-dimensional object in which a three-dimensional object is modeled by discharging a plasticized material from a nozzle toward a stage and curing the material.

For example, JP-A-2023-182086 describes a method for producing a three-dimensional object in a three-dimensional modeling apparatus including a nozzle having a nozzle opening and configured to discharge a modeling material from the nozzle opening toward a stage; a position changing unit configured to change a relative position between the nozzle and the stage; and a pressure adjusting unit having a branch flow path coupled to a flow path through which the modeling material flows and a plunger configured to move in the branch flow path.

JP-A-2023-182086 is an example of the related art.

In the method for producing a three-dimensional object as described above, it is desired to reduce a change in a line width of the material discharged from the nozzle and deposited on the stage.

### SUMMARY

A method for producing a three-dimensional object according to an aspect of the present disclosure in a three-dimensional modeling apparatus including a plasticizing unit including a screw and a motor configured to rotate the screw, the plasticizing unit being configured to plasticize a material to generate a plasticized material, a flow path configured to allow the plasticized material to pass therethrough, a nozzle including a nozzle opening and configured to discharge the plasticized material that passes through the flow path from the nozzle opening toward a stage, and a position changing unit configured to change a relative position between the stage and the nozzle, includes: a deceleration step of reducing a relative speed of the nozzle with respect to the stage, in which in the deceleration step, the screw is reversely rotated.

### BRIEF DESCRIPTION OF THE DRAWINGS

FIG. 1 is a cross-sectional view schematically illustrating a three-dimensional modeling apparatus according to the embodiment.

FIG. 2 is a perspective view schematically illustrating a screw of the three-dimensional modeling apparatus according to the embodiment.

FIG. 3 is a plan view schematically illustrating a barrel of the three-dimensional modeling apparatus according to the embodiment.

FIG. 4 is a flowchart illustrating processing of a control unit of the three-dimensional modeling apparatus according to the embodiment.

FIG. 5 is a cross-sectional view illustrating modeling processing performed by the control unit of the three-dimensional modeling apparatus according to the embodiment.

FIG. 6 is a flowchart illustrating screw rotation speed control processing performed by the control unit of the three-dimensional modeling apparatus according to the embodiment.

FIG. 7 is a flowchart illustrating a modification of the screw rotation speed control processing performed by the control unit of the three-dimensional modeling apparatus according to the embodiment.

FIG. 8 is a graph illustrating a variation rate of a line width with respect to an elapsed time.

### DESCRIPTION OF EMBODIMENTS

A preferable embodiment of the present disclosure will be described below in detail with reference to the drawings. The embodiment to be described below does not unduly limit the content of the present disclosure described in the claims. Further, not all of the configurations described below are necessarily essential elements of the present disclosure.

### 1. Three-Dimensional Modeling Apparatus

### 1.1. Overall Configuration

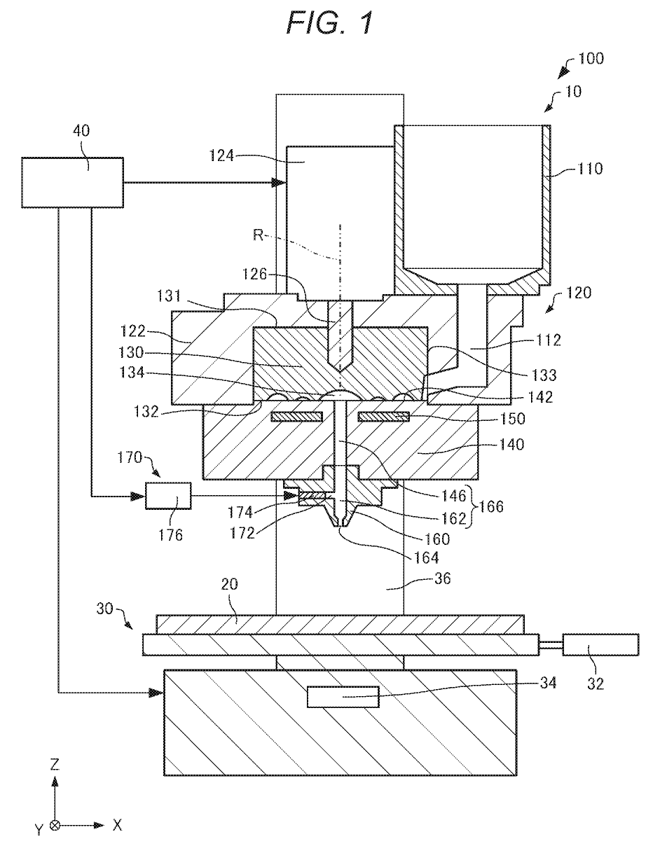

First, the three-dimensional modeling apparatus according to the embodiment is described with reference to the drawings. FIG. 1 is a cross-sectional view schematically illustrating a three-dimensional modeling apparatus 100 according to the embodiment. FIG. 1 illustrates an X axis, a Y axis, and a Z axis as three axes orthogonal to one another. An X-axis direction and a Y-axis direction are, for example, horizontal directions. A Z-axis direction is, for example, a vertical direction.

As illustrated in FIG. 1, the three-dimensional modeling apparatus 100 includes, for example, a discharging unit 10, a stage 20, a position changing unit 30, and a control unit 40.

While causing the discharging unit 10 to discharge a plasticized material toward the stage 20, the three-dimensional modeling apparatus 100 drives the position changing unit 30 to change relative positions between the discharging unit 10 and the stage 20. Accordingly, the three-dimensional modeling apparatus 100 models a three-dimensional object having a desired shape by depositing modeling layers on the stage 20. The three-dimensional modeling apparatus 100 is a three-dimensional modeling apparatus of a fused deposition modeling (FDM) type.

Although not illustrated, a plurality of discharging units 10 may be provided. Two discharging units 10 may be provided. In this case, both of the two discharging units 10 may discharge the plasticized material configuring the three-dimensional object or one may discharge the plasticized material and the other may discharge a support material that supports the three-dimensional object. The two discharging units 10 may be aligned in the X-axis direction.

As illustrated in FIG. 1, the discharging unit 10 includes, for example, a material supply unit 110, a plasticizing unit 120, a nozzle 160, and a pressure adjusting unit 170.

The material supply unit 110 stores a pellet-shaped or powdery material. The material supply unit 110 supplies the material to the plasticizing unit 120. The material supply unit 110 is implemented with, for example, a hopper. The material supplied by the material supply unit 110 is, for example, acrylonitrile butadiene styrene (ABS) resin.

The material supply unit 110 and the plasticizing unit 120 are coupled by a supply path 112 provided below the material supply unit 110. The material charged into the material supply unit 110 is supplied to the plasticizing unit 120 via the supply path 112.

The plasticizing unit 120 includes, for example, a screw case 122, a drive motor 124, a screw 130, a barrel 140, and a heater 150. The plasticizing unit 120 plasticizes at least a part of the material in a solid state supplied from the material supply unit 110, generates a paste-shaped plasticized material having fluidity, and supplies the plasticized material to the nozzle 160.

The term "plasticize" is a concept including melting, and means changing from a solid state to a state having fluidity. Specifically, in a case of a material in which glass transition occurs, the term "plasticize" means setting a temperature of the material to a temperature equal to or higher than a glass transition point. When glass transition does not occur in the material, the term "plasticize" means setting the temperature of the material to a value equal to or higher than a melting point.

The screw case 122 is a housing that houses the screw 130. The barrel 140 is provided at a lower surface of the screw case 122. The screw 130 is housed in a space surrounded by the screw case 122 and the barrel 140.

The drive motor 124 is provided at an upper surface of the screw case 122. The drive motor 124 is, for example, a servo motor. The shaft 126 of the drive motor 124 is coupled to an upper surface 131 of the screw 130. The drive motor 124 rotates the screw 130. The drive motor 124 is controlled by the control unit 40. The shaft 126 of the drive motor 124 and the upper surface 131 of the screw 130 may be coupled via a speed reducer.

The screw 130 is, for example, a flat screw having a substantially cylindrical shape in which a size in a direction of the rotation axis R is smaller than a size in a direction orthogonal to the direction of the rotation axis R. In the illustrated example, the rotation axis R is parallel to the Z axis. The screw 130 rotates about the rotation axis R with torque generated by the drive motor 124.

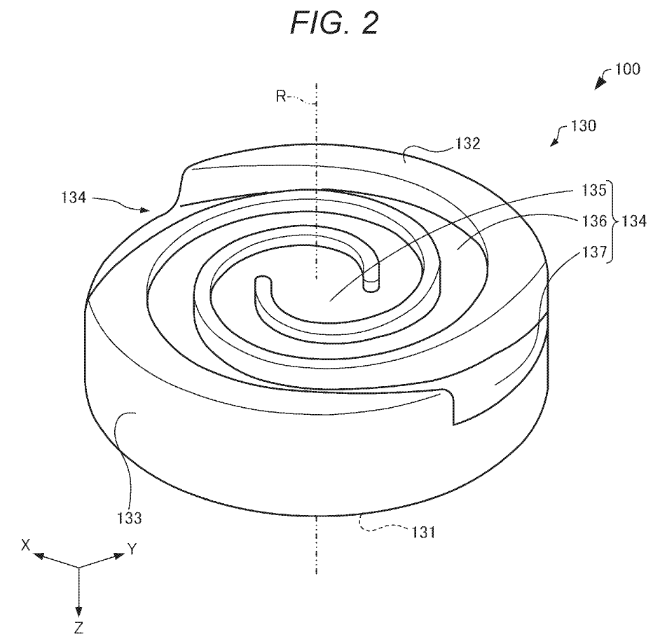

The screw 130 includes the upper surface 131, a groove forming surface 132 at an opposite side of the upper surface 131, and a side surface 133 coupling the upper surface 131 and the groove forming surface 132. A first groove 134 is formed at the groove forming surface 132. The side surface 133 is, for example, perpendicular to the groove forming surface 132. Here, FIG. 2 is a perspective view schematically illustrating the screw 130. For convenience, FIG. 2 illustrates a state in which an upper-lower positional relationship is reversed from a state illustrated in FIG. 1.

As illustrated in FIG. 2, the first groove 134 is formed at the groove forming surface 132 of the screw 130. The first groove 134 includes, for example, a central portion 135, a coupling portion 136, and a material introduction portion 137. The central portion 135 faces a communication hole 146 formed on the barrel 140. The central portion 135 communicates with the communication hole 146. The coupling portion 136 couples the central portion 135 and the material introduction portion 137. In the illustrated example, the coupling portion 136 is provided in a spiral shape from the central portion 135 toward an outer circumference of the groove forming surface 132. The material introduction portion 137 is provided at the outer circumference of the groove forming surface 132. That is, the material introduction portion 137 is provided at the side surface 133 of the screw 130. The material supplied from the material supply unit 110 is introduced from the material introduction portion 137 into the first groove 134, passes through the coupling portion 136 and the central portion 135, and is conveyed to the communication hole 146 formed on the barrel 140. For example, two first grooves 134 are formed.

The number of first grooves 134 is not particularly limited. Although not illustrated, three or more first grooves 134 may be formed or only one first groove 134 may be formed. Although not illustrated, the screw 130 may be an elongated in-line screw including a spiral groove on a side surface thereof instead of a flat screw.

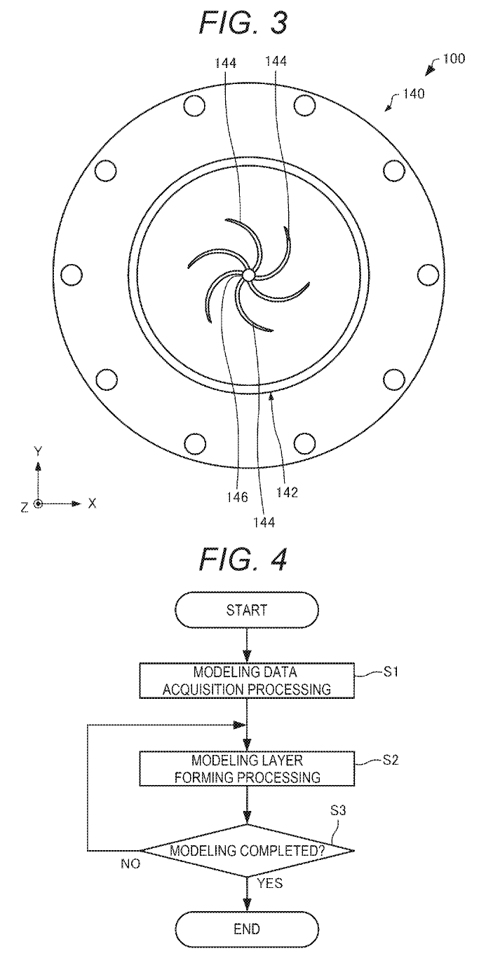

As illustrated in FIG. 1, the barrel 140 is provided below the screw 130. The barrel 140 includes a facing surface 142 facing the groove forming surface 132 of the screw 130. The communication hole 146 communicating with the first groove 134 is formed at the center of the facing surface 142. Here, FIG. 3 is a plan view schematically illustrating the barrel 140.

As illustrated in FIG. 3, a second groove 144 and the communication hole 146 are formed at the facing surface 142 of the barrel 140. A plurality of second grooves 144 are formed. In the illustrated example, six second grooves 144 are formed. However, the number of second grooves 144 is not particularly limited. The plurality of second grooves 144 are formed around the communication hole 146 as viewed from the Z-axis direction. One end of the second groove 144 is coupled to the communication hole 146 and extends spirally from the communication hole 146 toward an outer circumference of the barrel 140. The second grooves 144 have a function of guiding the plasticized material to the communication hole 146.

Although not illustrated, a shape of the second groove 144 is not particularly limited and may be, for example, a linear shape. The one end of the second groove 144 may not be coupled to the communication hole 146. Further, the second groove 144 may not be formed at the facing surface 142. In consideration of efficiently guiding the plasticized material to the communication hole 146, the second groove 144 is preferably formed at the facing surface 142.

As illustrated in FIG. 1, the heater 150 is provided on the barrel 140. The heater 150 heats the material supplied between the screw 130 and the barrel 140. An output of the heater 150 is controlled by the control unit 40. The plasticizing unit 120 heats the material while conveying the material toward the communication hole 146 by the screw 130, the barrel 140, and the heater 150 to generate the plasticized material. Then, the plasticizing unit 120 causes the generated plasticized material to flow out from the communication hole 146.

Although not illustrated, a shape of the heater 150 may be a ring shape when viewed in the Z-axis direction. The heater 150 may be provided below the barrel 140 instead of on the barrel 140.

The nozzle 160 is provided below the barrel 140. A nozzle flow path 162 is formed in the nozzle 160. The nozzle flow path 162 communicates with the communication hole 146. The plasticized material is supplied to the nozzle flow path 162 from the communication hole 146. The nozzle 160 discharges the plasticized material supplied to the nozzle flow path 162 from a nozzle opening 164 toward the stage 20. The nozzle flow path 162 and the communication hole 146 form a flow path 166. The three-dimensional modeling apparatus 100 includes the flow path 166. In the illustrated example, the flow path 166 extends in the Z-axis direction. The plasticized material passes through the flow path 166. The nozzle 160 discharges the plasticized material that passes through the flow path 166 from the nozzle opening 164 toward the stage 20.

The pressure adjusting unit 170 is provided at a side of the flow path 166. The pressure adjusting unit 170 includes, for example, a branch flow path 172, a plunger 174, and a drive unit 176. The branch flow path 172 is coupled to the flow path 166. The branch flow path 172 branches from the flow path 166. In the illustrated example, the branch flow path 172 is coupled to the nozzle flow path 162. The branch flow path 172 extends in the X-axis direction. Although not illustrated, the branch flow path 172 may be coupled to the communication hole 146. The plunger 174 moves in the branch flow path 172. In the illustrated example, the plunger 174 moves in the X-axis direction. The drive unit 176 moves the plunger 174. The drive unit 176 includes, for example, a motor. The drive unit 176 is controlled by the control unit 40.

The pressure adjusting unit 170 adjusts a pressure of the flow path 166. Specifically, the pressure in the flow path 166 can be reduced by moving the plunger 174 in a direction away from the flow path 166. Conversely, the pressure of the flow path 166 can be increased by moving the plunger 174 in a direction approaching the flow path 166.

The stage 20 is provided below the nozzle 160. In the illustrated example, a shape of the stage 20 is a rectangular parallelepiped. The plasticized material discharged from the nozzle 160 is deposited on the stage 20. A material for the stage 20 is, for example, metal such as aluminum.

The position changing unit 30 supports the stage 20. The position changing unit 30 changes relative positions between the discharging unit 10 and the stage 20. That is, the position changing unit 30 changes relative positions between the nozzle 160 and the stage 20. The nozzle 160 is moved with respect to the stage 20 by the position changing unit 30. In the illustrated example, the position changing unit 30 moves the stage 20 in the X-axis direction and the Y-axis direction, thereby changing the relative positions between the discharging unit 10 and the stage 20 in the X-axis direction and the Y-axis direction. Further, the position changing unit 30 moves the discharging unit 10 in the Z-axis direction, thereby changing the relative positions between the discharging unit 10 and the stage 20 in the Z-axis direction.

The position changing unit 30 includes, for example, a first electric actuator 32, a second electric actuator 34, and a third electric actuator 36. The first electric actuator 32 moves the stage 20 in the X-axis direction. The second electric actuator 34 moves the stage 20 in the Y-axis direction. The third electric actuator 36 moves the discharging unit 10 in the Z-axis direction. The electric actuators 32, 34, and 36 are controlled by the control unit 40.

A configuration of the position changing unit 30 is not particularly limited as long as the position changing unit 30 can change the relative positions between the discharging unit 10 and the stage 20. For example, the position changing unit 30 may move the stage 20 in the Z-axis direction and move the discharging unit 10 in the X-axis direction and the Y-axis direction. The position changing unit 30 may fix the stage 20 and move the discharging unit 10 in the X-axis direction, the Y-axis direction, and the Z-axis direction. The position changing unit 30 may fix the discharging unit 10 and move the stage 20 in the X-axis direction, the Y-axis direction, and the Z-axis direction.

The control unit 40 is implemented with, for example, a computer including a processor, a main storage device, and an input/output interface for inputting and outputting signals from and to an outside. The control unit 40 exerts various functions, for example, by the processor executing a program read into the main storage device. Specifically, the control unit 40 controls the discharging unit 10 and the position changing unit 30. The control unit 40 may include a combination of a plurality of circuits rather than the computer.

### 1.2. Operation

### 1.2.1. Overall Flow

FIG. 4 is a flowchart illustrating an operation of the three-dimensional modeling apparatus 100. Specifically, FIG. 4 is a flowchart illustrating processing of the control unit 40 of the three-dimensional modeling apparatus 100.

For example, a user operates an operation unit (not illustrated) to output, to the control unit 40, a processing start signal for starting processing. The operation unit is implemented with, for example, a mouse, a keyboard, or a touch panel. When receiving the processing start signal, the control unit 40 starts the processing.

First, as illustrated in FIG. 4, in step S1, the control unit 40 performs modeling data acquisition processing of acquiring modeling data for modeling a three-dimensional object.

The modeling data includes, for example, a type of the material stored in the material supply unit 110, information on a path of the nozzle 160 with respect to the stage 20, information on a relative speed of the nozzle 160 with respect to the stage 20 according to the path, information on a rotation speed of the screw 130 according to the relative speed, and information on a discharge amount of the plasticized material from the nozzle 160 in the path.

The modeling data is created by, for example, causing slicer software installed in a computer coupled to the three-dimensional modeling apparatus 100 to read shape data. The shape data is data representing a target shape of a three-dimensional object created using three-dimensional computer aided design (CAD) software, three-dimensional computer graphics (CG) software, or the like. As the shape data, for example, data in a standard triangulated language (STL) format or an additive manufacturing file format (AMF) is used. The slicer software divides the target shape of the three-dimensional object into layers each having a predetermined thickness, and creates modeling data for each layer. The modeling data is represented by a G code, an M code, or the like. The control unit 40 acquires modeling data from a computer coupled to the three-dimensional modeling apparatus 100 or from a recording medium such as a universal serial bus (USB) memory.

Next, in step S2, the control unit 40 controls the discharging unit 10 and the position changing unit 30 based on the modeling data to perform modeling layer forming processing of discharging the plasticized material from the discharging unit 10 toward the stage 20 to form a modeling layer.

Specifically, the control unit 40 plasticizes the material supplied between the screw 130 and the barrel 140 to generate the plasticized material, and discharges the plasticized material from the nozzle 160 of the discharging unit 10. The control unit 40 continues to generate the plasticized material until the modeling layer forming processing is ended.

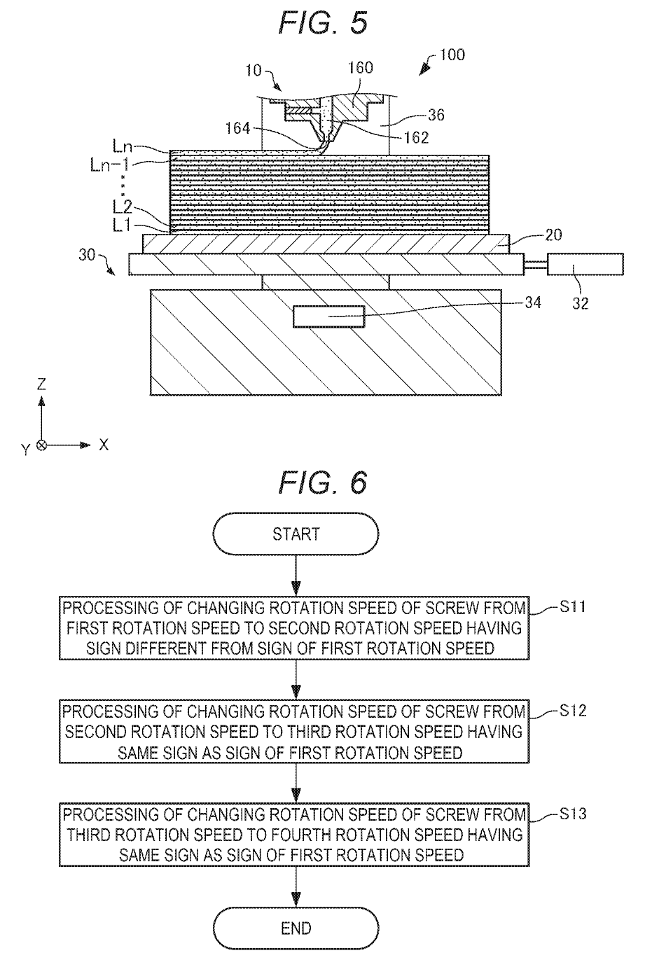

Here, FIG. 5 is a cross-sectional view illustrating the modeling layer forming processing performed by the control unit 40 of the three-dimensional modeling apparatus 100.

As illustrated in FIG. 5, while controlling the position changing unit 30 to change the relative positions between the discharging unit 10 and the stage 20, the control unit 40 controls, based on the acquired modeling data, the discharging unit 10 to discharge the plasticized material that is plasticized from the nozzle 160 toward the stage 20.

Specifically, before the modeling layer forming processing is started, that is, before formation of a modeling layer L1, which is a first modeling layer, is started, the nozzle 160 is disposed at an initial position in a -X-axis direction relative to an end portion of the stage 20 in the -X-axis direction. When the modeling layer forming processing is started, as illustrated in FIG. 5, the control unit 40 controls the position changing unit 30 to, for example, move the nozzle 160 relative to the stage 20 in the +X-axis direction. When the nozzle 160 passes over the stage 20, the plasticized material is discharged from the nozzle 160. Accordingly, the modeling layer L1 is formed. In FIG. 5, modeling layers up to an n-th modeling layer Ln are illustrated, with n being any natural number.

Next, as illustrated in FIG. 4, in step S3, the control unit 40 performs determination processing of determining whether the formation of all the modeling layers is completed based on the modeling data.

When it is determined that the formation of all the modeling layers is not completed ("NO" in step S3), the control unit 40 returns the processing to step S2. The control unit 40 repeats steps S2 and S3 until it is determined in step S3 that the formation of all the modeling layers is completed.

Meanwhile, when it is determined that the formation of all the modeling layers is completed ("YES" in step S3), the control unit 40 ends the processing.

### 1.2.2. Deceleration Processing in Modeling Layer Forming Processing

In the modeling layer forming processing, the control unit 40 performs nozzle deceleration processing of reducing a relative speed of the nozzle 160 with respect to the stage 20 (hereinafter, also referred to as a "nozzle speed"). Specifically, the control unit 40 controls the position changing unit 30 based on information on the nozzle speed in the modeling data to reduce the nozzle speed. For example, when the path of the nozzle 160 with respect to the stage 20 is bent, the control unit 40 reduces the nozzle speed before a bent portion.

In the nozzle deceleration processing, based on information on a rotation speed of the screw 130 corresponding to the nozzle speed in the modeling data, the control unit 40 performs screw rotation speed control processing of controlling the rotation speed of the screw 130 by controlling the drive motor 124. For example, in a case where the nozzle speed decreases, when the rotation speed of the screw is constant, a discharge amount of the plasticized material from the nozzle increases, and a line width increases. Therefore, the control unit 40 performs the screw rotation speed control processing in the nozzle deceleration processing.

Here, FIG. 6 is a flowchart illustrating the screw rotation speed control processing performed by the control unit 40. After starting the nozzle deceleration processing, the control unit 40 starts the screw rotation speed control processing. Hereinafter, the screw rotation speed control processing performed by the control unit 40 will be described.

As illustrated in FIG. 6, in step S11, the control unit 40 controls the drive motor 124 based on the modeling data to perform processing of changing the rotation speed of the screw 130 from a first rotation speed to a second rotation speed having a sign different from a sign of the first rotation speed. That is, the control unit 40 reversely rotates the screw 130 rotating at the first rotation speed to rotate the screw 130 at the second rotation speed. An absolute value of the second rotation speed is, for example, larger than an absolute value of the first rotation speed. Since an operation delay of the screw 130 with respect to a signal from the control unit 40 may occur immediately after the reverse rotation, the line width can be quickly adjusted by making the absolute value of the second rotation speed larger than the absolute value of the first rotation speed. The control unit 40 continues to rotate the screw 130 at the second rotation speed for a predetermined period based on the modeling data.

Next, in step S12, the control unit 40 controls the drive motor 124 based on the modeling data to perform processing of changing the rotation speed of the screw 130 from the second rotation speed to a third rotation speed having the same sign as the sign of the first rotation speed. That is, the control unit 40 reversely rotates the screw 130 rotating at the second rotation speed to rotate the screw 130 at the third rotation speed. The third rotation speed is, for example, greater than the first rotation speed and a fourth rotation speed. An absolute value of the third rotation speed is, for example, larger than the absolute value of the second rotation speed. The control unit 40 continues to rotate the screw 130 at the third rotation speed for a predetermined period based on the modeling data.

Next, in step S13, the control unit 40 controls the drive motor 124 based on the modeling data to perform processing of changing the rotation speed of the screw 130 from the third rotation speed to the fourth rotation speed having the same sign as the sign of the first rotation speed. The fourth rotation speed is lower than the first rotation speed and the third rotation speed. An absolute value of the fourth rotation speed is, for example, less than the absolute value of the second rotation speed.

Then, the control unit 40 ends the screw rotation speed control processing.

While performing the screw rotation speed control processing, the control unit 40 controls, for example, the drive unit 176 of the pressure adjusting unit 170 to perform processing of moving the plunger 174 along the branch flow path 172 so as to separate the plunger 174 from the flow path 166. In other words, the control unit 40 causes the plunger 174 to be sucked back. For example, the control unit 40 moves the plunger 174 away from the flow path 166 after the processing of step S11 and before the processing of step S12. Accordingly, the line width can be finely adjusted.

For example, during the processing of step S12, the control unit 40 controls the drive unit 176 to move the plunger 174 so as to approach the flow path 166. Accordingly, the plunger 174 moved away from the flow path 166 can be returned to a predetermined position.

The control unit 40 may move the plunger 174 away from the flow path 166 based on the modeling data. Alternatively, the control unit 40 may determine whether the line width is within a predetermined value based on an image captured by a camera (not illustrated), and move the plunger 174 away from the flow path 166 when the line width exceeds the predetermined value.

In a method for producing a three-dimensional object according to the embodiment, the three-dimensional object is produced using the three-dimensional modeling apparatus 100.

### 1.3. Functions and Effects

The method for producing a three-dimensional object according to the embodiment is a method for producing a three-dimensional object in the three-dimensional modeling apparatus 100, and includes a deceleration step of reducing the relative speed of the nozzle 160 with respect to the stage 20. In the deceleration step, the screw 130 is reversely rotated. Therefore, in the method for producing a three-dimensional object according to the embodiment, by reversely rotating the screw 130, the pressure of the flow path 166 can be quickly reduced, and a time until the pressure of the flow path 166 reaches a steady value can be shortened. Accordingly, a change in the line width of the material discharged from the nozzle 160 and deposited on the stage 20 can be reduced. For example, even when a path of the nozzle 160 with respect to the stage 20 is complicated, the line width of the material deposited on the stage 20 can be kept constant.

In the method for producing a three-dimensional object according to the embodiment, the deceleration step includes changing the rotation speed of the screw 130 from the first rotation speed to the second rotation speed having the sign different from the sign of the first rotation speed, changing the rotation speed of the screw 130 from the second rotation speed to the third rotation speed having the same sign as the sign of the first rotation speed, and changing the rotation speed of the screw 130 from the third rotation speed to the fourth rotation speed having the same sign as the sign of the first rotation speed. The third rotation speed is greater than the fourth rotation speed. Therefore, in the method for producing a three-dimensional object according to the embodiment, the line width reduced by setting the rotation speed to the second rotation speed can be returned to an original line width by setting the rotation speed to the third rotation speed.

In the method for producing a three-dimensional object according to the embodiment, the absolute value of the second rotation speed is larger than the absolute value of the first rotation speed. Therefore, in the method for producing a three-dimensional object according to the embodiment, the line width can be reduced in a short time by setting the rotation speed to the second rotation speed.

In the method for producing a three-dimensional object according to the embodiment, the absolute value of the third rotation speed is larger than the absolute value of the second rotation speed. Therefore, in the method for producing a three-dimensional object according to the embodiment, it is possible to prevent the line width from being too thin by setting the rotation speed to the third rotation speed.

In the method for producing a three-dimensional object according to the embodiment, in the nozzle deceleration step, the plunger 174 moves along the branch flow path 172 so as to separate from the flow path 166. Therefore, in the method for producing a three-dimensional object according to the embodiment, the line width can be reduced by the plunger 174.

### 2. Modification of Processing of Control Unit

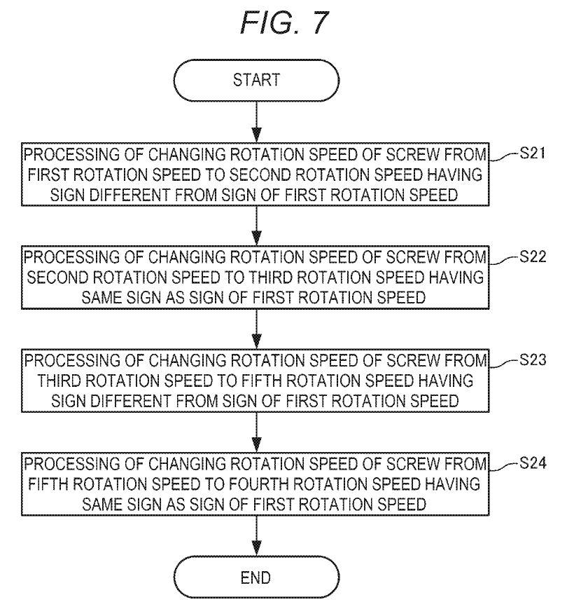

Next, a modification of the processing of the control unit 40 of the three-dimensional modeling apparatus 100 according to the embodiment will be described with reference to the drawings. FIG. 7 is a flowchart illustrating processing of the control unit 40. Specifically, FIG. 7 is a flowchart illustrating the screw rotation speed control processing performed by the control unit 40.

Hereinafter, in the modification of the processing of the control unit 40 of the three-dimensional modeling apparatus 100 according to the embodiment, differences from the example of the processing of the control unit 40 of the three-dimensional modeling apparatus 100 according to the embodiment described above will be described, and description of similar points will be omitted.

In a modification of the processing of the control unit 40, as illustrated in FIG. 7, processing of step S21 and processing of step S22 are performed. The processing of step S21 and the processing of step S22 are basically the same as the processing of step S11 and the processing of step S12 described above, respectively.

Next, in step S23, the control unit 40 controls the drive motor 124 based on the modeling data to perform processing of changing the rotation speed of the screw 130 from the third rotation speed to a fifth rotation speed having a sign different from the sign of the first rotation speed. That is, the control unit 40 reversely rotates the screw 130 rotating at the third rotation speed to rotate the screw 130 at the fifth rotation speed.

An absolute value of the fifth rotation speed is, for example, less than the absolute value of the second rotation speed. A variation in the line width tends to be large at an initial stage and then gentle. Therefore, by making the absolute value of the second rotation speed larger than the absolute value of the fifth rotation speed, the pressure of the flow path 166 can be controlled to adapt to the variation in the line width. The absolute value of the fifth rotation speed is, for example, larger than the absolute value of the first rotation speed and the absolute value of the fourth rotation speed. The absolute value of the fifth rotation speed is, for example, less than the absolute value of the third rotation speed.

The control unit 40 continues to rotate the screw 130 at the fifth rotation speed for a predetermined period based on the modeling data. A period during which the screw 130 is continuously rotated at the fifth rotation speed is longer than, for example, a period during which the screw 130 is continuously rotated at the second rotation speed and a period during which the screw 130 is continuously rotated at the third rotation speed.

Next, in step S24, the control unit 40 controls the drive motor 124 based on the modeling data to perform processing of changing the rotation speed of the screw 130 from the fifth rotation speed to the fourth rotation speed having the same sign as the first rotation speed. That is, the control unit 40 reversely rotates the screw 130 rotating at the fifth rotation speed to rotate the screw 130 at the fourth rotation speed.

Then, the control unit 40 ends the processing of controlling the rotation speed of the screw 130.

In the method for producing a three-dimensional object according to the embodiment, for example, a three-dimensional object is produced using the modification of the processing of the control unit 40 of the three-dimensional modeling apparatus 100 described above.

In the method for producing a three-dimensional object according to the embodiment, the deceleration step includes changing the rotation speed of the screw 130 from the third rotation speed to the fifth rotation speed having the sign different from the sign of the first rotation speed between changing the rotation speed to the third rotation speed and changing the rotation speed to the fourth rotation speed. In changing the rotation speed to the fourth rotation speed, the rotation speed of the screw 130 is changed from the fifth rotation speed to the fourth rotation speed. Therefore, in the method for producing a three-dimensional object according to the embodiment, the line width excessively increased in setting the rotation speed to the third rotation speed can be set to an appropriate line width by setting the rotation speed to the fifth rotation speed.

### 3. Modification of Material for Three-Dimensional Modeling Apparatus

Next, a modification of the material for the three-dimensional modeling apparatus 100 according to the embodiment will be described.

In the three-dimensional modeling apparatus 100 described above, the material supplied from the material supply unit 110 to the plasticizing unit 120 is the ABS resin. However, the material supplied from the material supply unit 110 to the plasticizing unit 120 may be a material other than the ABS resin or a material obtained by adding another component to the ABS resin.

Examples of the material supplied from the material supply unit 110 include materials containing various materials such as a thermoplastic material, a metal material, and a ceramic material as main materials. Here, the "main material" means a material mainly forming a shape of the three-dimensional object produced by the three-dimensional modeling apparatus 100 and means a material occupying a content of 50 mass% or more in the three-dimensional object. The material described above includes a material obtained by melting the main material alone and a material obtained by melting a part of components contained together with the main material into a paste form.

Examples of the thermoplastic material include thermoplastic resin. Examples of the thermoplastic resin include general-purpose plastic, general-purpose engineering plastic, and super engineering plastic.

Examples of the general-purpose plastic include polypropylene (PP), polyethylene (PE), polyvinyl chloride (PVC), and polylactic acid (PLA).

Examples of the general-purpose engineering plastic include polyacetal (POM), polyamide (PA), polycarbonate (PC), modified polyphenylene ether (m-PPE), polybutylene terephthalate (PBT), and polyethylene terephthalate (PET).

Examples of the super engineering plastic include polysulfone (PSU), polyethersulfone (PES), polyphenylene sulfide (PPS), polyarylate (PAR), polyimide (PI), polyamideimide (PAI), polyetherimide (PEI), and polyetheretherketone (PEEK).

Additives such as pigments, metal, ceramic, waxes, flame retardants, antioxidants, and heat stabilizers may be mixed into the thermoplastic material. In the plasticizing unit 120, the thermoplastic material is plasticized and converted into a molten state by rotation of the screw 130 and heating of the heater 150. The plasticized material generated as described above is discharged from the nozzle 160 and deposited on the stage 20 and is thereafter cured by a temperature drop.

In the plasticizing unit 120, for example, a metal material may be used as the main material instead of the above-described thermoplastic material. In this case, it is desirable that a powder material obtained by forming the metal material into powder is mixed with a component that melts when the plasticized material is generated, and a mixture is charged into the plasticizing unit 120.

Examples of the metal material include single metal such as magnesium (Mg), iron (Fe), cobalt (Co), chromium (Cr), aluminum (Al), titanium (Ti), copper (Cu), and nickel (Ni) or an alloy containing one or more of these kinds of metal, maraging steel, stainless steel, cobalt chromium molybdenum, a titanium alloy, a nickel alloy, an aluminum alloy, a cobalt alloy, and a cobalt chromium alloy.

In the plasticizing unit 120, a ceramic material can be used as the main material instead of the metal material described above. Examples of the ceramic material include oxide ceramic such as silicon dioxide, titanium dioxide, aluminum oxide, and zirconium oxide and non-oxide ceramic such as aluminum nitride.

A powder material for the metal material or the ceramic material supplied from the material supply unit 110 may be a mixed material obtained by mixing a plurality of kinds of single metal powder, alloy powder, and ceramic material powder. The powder material for the metal material or the ceramic material may be coated with, for example, the thermoplastic resin described above or other thermoplastic resin. In this case, in the plasticizing unit 120, the thermoplastic resin may be melted to exhibit fluidity.

For example, a solvent can be added to the powder material for the metal material or the ceramic material supplied from the material supply unit 110. Examples of the solvent include: water; (poly)alkylene glycol monoalkyl ethers such as ethylene glycol monomethyl ether, ethylene glycol monoethyl ether, propylene glycol monomethyl ether, and propylene glycol monoethyl ether; acetic acid esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; alcohols such as ethanol, propanol, and butanol; tetraalkylammonium acetates; sulfoxide-based solvents such as dimethyl sulfoxide and diethyl sulfoxide; pyridine-based solvents such as pyridine, γ-picoline, and 2,6-lutidine; tetraalkylammonium acetates (for example, tetrabutylammonium acetate); and ionic liquids such as butyl carbitol acetate.

In addition, for example, a binder may be added to the powder material for the metal material or the ceramic material supplied from the material supply unit 110. Examples of the binder include acrylic resin, epoxy resin, silicone resin, cellulose-based resin, and other synthetic resin, PLA, PA, PPS, PEEK, and other thermoplastic resins.

### 4. Examples and Comparative Examples

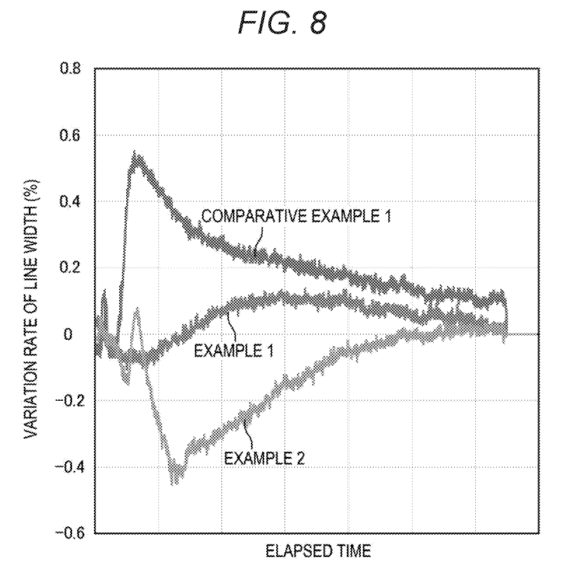

A plasticized material was discharged from a nozzle of a three-dimensional modeling apparatus corresponding to the three-dimensional modeling apparatus 100 described above toward a stage, and a line width of the material deposited on the stage was measured when a rotation speed of a flat screw was changed from 5 rpm to 1.7 rpm. FIG. 8 is a graph illustrating a variation rate of the line width with respect to an elapsed time.

In Example 1, the rotation speed of the flat screw was maintained at -12 rpm from 5 rpm for 40 ms, then maintained at 25 rpm for 40 ms, and then maintained at -6 rpm for 120 ms, and then set at 1.7 rpm.

Example 2 is the same as Example 1 described above except that the rotation speed of the flat screw is maintained at -12 rpm from 5 rpm for 80 ms.

In Comparative Example 1, the rotation speed of the flat screw was directly changed from 5 rpm to 1.7 rpm.

In the above description, a sign of the rotation speed when the flat screw is reversely rotated is negative.

As illustrated in FIG. 8, in Examples 1 and 2, a variation in the line width was smaller and a time for stabilizing the line width was shorter than in Comparative Example 1. In Example 1, the variation in the line width was smaller than that in Example 2. The line width was stabilized in a shorter time in Example 2 than in Example 1.

From the above, it was found that the variation in the line width can be reduced by reversely rotating the screw.

The embodiment and modifications described above are merely examples, and the present disclosure is not limited thereto. For example, the embodiments and the modifications may be combined as appropriate.

The present disclosure includes substantially the same configurations as the configurations described in the embodiment, such as configurations having the same functions, methods, and results, or configurations having the same objects and effects. The present disclosure further includes a configuration in which a non-essential portion of the configuration described in the embodiment is replaced with another portion. The present disclosure includes a configuration that has the same functions and effects as those of the configuration described in the embodiment or a configuration that can achieve the same objects as those achieved by the configuration. The present disclosure includes a configuration with the addition of a known technique to the configuration described in the embodiment.

The following contents can be derived from the embodiment and modifications described above.

A method for producing a three-dimensional object according to an aspect in a three-dimensional modeling apparatus including a plasticizing unit including a screw and a motor configured to rotate the screw, the plasticizing unit being configured to plasticize a material to generate a plasticized material, a flow path configured to allow the plasticized material to pass therethrough, a nozzle including a nozzle opening and configured to discharge the plasticized material that passes through the flow path from the nozzle opening toward a stage, and a position changing unit configured to change a relative position between the stage and the nozzle, includes: a deceleration step of reducing a relative speed of the nozzle with respect to the stage, in which in the deceleration step, the screw is reversely rotated.

According to the method for producing a three-dimensional object, it is possible to reduce a change in a line width of the material discharged from the nozzle and deposited on the stage.

In the method for producing a three-dimensional object according to the aspect, the deceleration step may include changing a rotation speed of the screw from a first rotation speed to a second rotation speed having a sign different from a sign of the first rotation speed, changing the rotation speed of the screw from the second rotation speed to a third rotation speed having the same sign as the sign of the first rotation speed, and changing the rotation speed of the screw from the third rotation speed to a fourth rotation speed having the same sign as the sign of the first rotation speed, and the third rotation speed may be greater than the fourth rotation speed.

According to the method for producing a three-dimensional object, the line width reduced by setting the rotation speed to the second rotation speed can be returned to an original line width by setting the rotation speed to the third rotation speed.

In the method for producing a three-dimensional object according to the aspect, the deceleration step may include changing the rotation speed of the screw from the third rotation speed to a fifth rotation speed having a sign different from the sign of the first rotation speed between changing the rotation speed to the third rotation speed and changing the rotation speed to the fourth rotation speed, and in changing the rotation speed to the fourth rotation speed, the rotation speed of the screw may be changed from the fifth rotation speed to the fourth rotation speed.

According to the method for producing a three-dimensional object, the line width excessively increased in setting the rotation speed to the third rotation speed can be set to an appropriate line width by setting the rotation speed to the fifth rotation speed.

In the method for producing a three-dimensional object according to the aspect, an absolute value of the second rotation speed is larger than an absolute value of the first rotation speed.

According to the method for producing a three-dimensional object, the line width can be reduced in a short time by setting the rotation speed to the second rotation speed.

In the method for producing a three-dimensional object according to the aspect, an absolute value of the third rotation speed is larger than an absolute value of the second rotation speed.

According to the method for producing a three-dimensional object, it is possible to prevent the line width from being too thin by setting the rotation speed to the third rotation speed.

In the method for producing a three-dimensional object according to the aspect, the three-dimensional modeling apparatus may include a pressure adjusting unit including a branch flow path coupled to the flow path and a plunger configured to move in the branch flow path, and in the deceleration step, the plunger may move in the branch flow path to be separated from the flow path.

According to the method for producing a three-dimensional object, the line width can be reduced by the plunger.

What is claimed is:

1. A method for producing a three-dimensional object in a three-dimensional modeling apparatus including a plasticizing unit including a screw and a motor configured to rotate the screw, the plasticizing unit being configured to plasticize a material to generate a plasticized material, a flow path configured to allow the plasticized material to pass therethrough, a nozzle including a nozzle opening and configured to discharge the plasticized material that passes through the flow path from the nozzle opening toward a stage, and a position changing unit configured to change a relative position between the stage and the nozzle, the method comprising:
a deceleration step of reducing a relative speed of the nozzle with respect to the stage, wherein
in the deceleration step, the screw is reversely rotated.

2. The method for producing a three-dimensional object according to claim 1, wherein
the deceleration step includes
changing a rotation speed of the screw from a first rotation speed to a second rotation speed having a sign different from a sign of the first rotation speed,
changing the rotation speed of the screw from the second rotation speed to a third rotation speed having the same sign as the sign of the first rotation speed, and
changing the rotation speed of the screw from the third rotation speed to a fourth rotation speed having the same sign as the sign of the first rotation speed, and
the third rotation speed is greater than the fourth rotation speed.

3. The method for producing a three-dimensional object according to claim 2, wherein
the deceleration step includes changing the rotation speed of the screw from the third rotation speed to a fifth rotation speed having a sign different from the sign of the first rotation speed between changing the rotation speed to the third rotation speed and changing the rotation speed to the fourth rotation speed, and
in changing the rotation speed to the fourth rotation speed, the rotation speed of the screw is changed from the fifth rotation speed to the fourth rotation speed.

4. The method for producing a three-dimensional object according to claim 2, wherein
an absolute value of the second rotation speed is larger than an absolute value of the first rotation speed.

5. The method for producing a three-dimensional object according to claim 4, wherein
an absolute value of the third rotation speed is larger than the absolute value of the second rotation speed.

6. The method for producing a three-dimensional object according to claim 1, wherein
the three-dimensional modeling apparatus includes a pressure adjusting unit including a branch flow path coupled to the flow path and a plunger configured to move in the branch flow path, and
in the deceleration step, the plunger moves in the branch flow path to be separated from the flow path.
